(19) United States
(12) Patent Application Publication
(10) Pub. No.: US 2009/0028171 A1
(43) Pub. Date: Jan. 29, 2009

(54) FIFO BUFFER WITH ADAPTIVE THRESHOLD LEVEL

(75) Inventors: Benoit COUSSON, Saint Laurent du Var (FR); Patrick Titiano, Saint Laurent du Var (FR)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/930,234

(22) Filed: Oct. 31, 2007

(30) Foreign Application Priority Data
Jul. 27, 2007 (EP) 07290951.8

(51) Int. Cl. H04L 12/56

(52) U.S. Cl. 370/412

(57) ABSTRACT

A system comprising a FIFO data buffer having a programmable threshold level, which is initially set to a worst case scenario level, so that the FIFO data buffer does not empty of data. The system also comprises a hardware device which is configured to adjust the threshold level in the FIFO data buffer to a level equal to the current threshold level minus the amount of remaining data in the FIFO data buffer at the time new data enters the FIFO data buffer. The hardware device is also configured to adjust the threshold level to the initial threshold level if the FIFO data buffer underflows. The hardware device may be coupled to the FIFO data buffer, implemented in the FIFO data buffer, or implemented in the display subsystem. The system may be implemented in a mobile communications device.

### CROSS-REFERENCE TO RELATED APPLICATIONS

This application claims priority to EPO Patent Application No. 07290951.8, filed on Jul. 27, 2007, incorporated herein by reference.

### BACKGROUND

A mobile communication device, such as a cell phone, requires batteries in order for users to use the device away from a fixed power source. These batteries only last a certain amount of time based on the amount of power requirements that the communication device requires. The mobile communication device usually contains at least some processing logic (e.g., a system on a chip) and a display subsystem (e.g., LCD display) which both draw power from the batteries. The lower the amount of power drawn by the processing logic and the display subsystem, the longer the battery will last without recharging. This allows users the ability to be away from a fixed power source for longer periods of time. Thus, it would be desirable to design a system which lowers power consumption in mobile communication devices.

### SUMMARY

The problem noted above is solved in large part by a system and method for adjusting a threshold level of a first-in-first out (FIFO) data buffer (buffers data being sent from the processing logic to the display subsystem). In some embodiments, the system includes a FIFO data buffer having a programmable threshold level. The threshold level is initially set to a worst case scenario level, so that the FIFO data buffer does not empty of data. The system also comprises a hardware device which is configured to adjust the threshold level in the FIFO data buffer to a level equal to the current threshold level minus the amount of remaining data in the FIFO data buffer at the time new data enters the FIFO data buffer. The hardware device is also configured to adjust the threshold level to the initial threshold level if the FIFO data buffer underflows. The hardware device may be coupled to the FIFO data buffer, implemented in the FIFO data buffer, or implemented in the display subsystem. The system may be implemented in a mobile communications device.

Another illustrative embodiment includes a method that comprises reading data from a FIFO data buffer, detecting whether the data in the FIFO data buffer has crossed a threshold level, lowering the threshold level if there would be data left in the FIFO data buffer upon reception of new data in the FIFO data buffer, and adjusting the threshold level back to the initial threshold level if the FIFO data buffer underflows.

Yet another illustrative embodiment includes a system comprising means for reading data from a FIFO data buffer, means for detecting whether a FIFO buffer threshold level has been crossed, and means for lowering the threshold level. The system also includes means for adjusting the threshold level to an initial threshold level if the FIFO data buffer underflows and means for storing new data in the FIFO data buffer when the threshold level is crossed.

### BRIEF DESCRIPTION OF THE DRAWINGS

For a detailed description of various disclosed embodiments, reference will now be made to the accompanying drawings in which:

FIG. 1 shows an illustrative mobile communication device implementing the technique disclosed herein, in accordance with preferred embodiments of the invention;

FIG. 2 shows an illustrative block diagram of at least some of the contents of the mobile communication device of FIG. 1, in accordance with embodiments of the invention;

FIG. 3 shows an illustrative flow diagram of a method implemented in accordance with embodiments of the invention; and

FIG. 4 shows a conceptual illustration of the technique disclosed herein, in accordance with embodiments of the invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to suggest that the scope of the disclosure, including the claims, is limited to that embodiment.

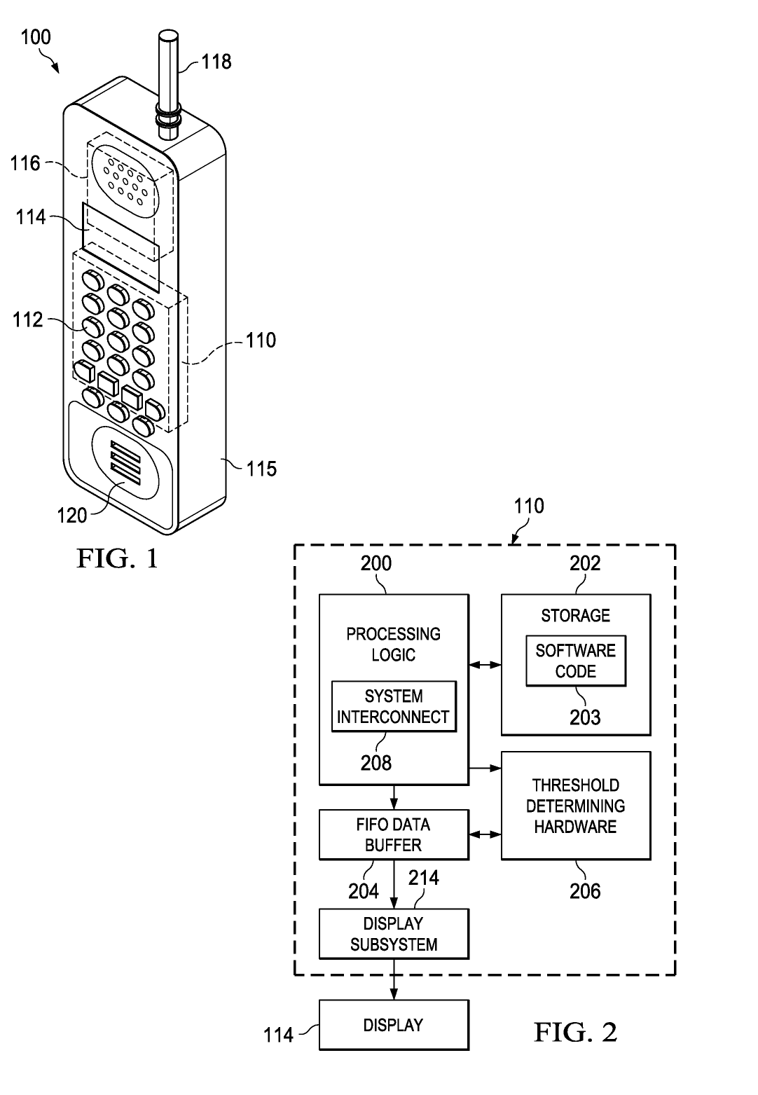

FIG. 1 shows an illustrative mobile communication device 100 (e.g., a mobile phone) implementing the disclosed technique in accordance with various embodiments of the invention. The device 100 comprises a battery-operated device which includes an integrated keypad 112 and display 114. The device 100 is represented as having a liquid crystal display (LCD); however, a display other than an LCD may be used instead. The device 100 also includes an electronics package 110 coupled to the keypad 112 and radio frequency (“RF”) circuitry 116. The electronics package 110 contains various electronic components used by the device 100, including processing logic, storage logic, etc. The RF circuitry 116 may couple to an antenna 118 by which data transmissions are sent and received. The device 100 also comprises a microphone 120. Although the mobile communication device 100 is represented as a mobile phone in FIG. 1, the scope of disclosure is not limited to mobile phones and also may include personal digital assistants, multi-purpose audio devices, portable computers or any other suitable electronic device. In at least some embodiments, the disclosed technique may be used in devices other than mobile communication devices.

FIG. 2 shows at least some of the contents of the electronics package 110. The electronics package 110 comprises processing logic 200 comprising system interconnect 208, a storage 202 comprising software code 203, a first-in, first-out (FIFO) data buffer 204, and a display subsystem 214. The storage 202 may comprise a processor (computer)-readable medium such as volatile memory (e.g., random access memory), non-volatile storage (e.g., read-only memory), a hard drive, Flash memory, etc. Although storage 202 is represented in FIG. 2 as being a single storage unit, in some embodiments, the storage 202 comprises a plurality of discrete storage units of the same or different types. Display subsystem 214 may include any combination of hardware and software which is associated with the visual representation of data in a system. Display subsystem 214 connects to display 114 so that end users may view requested data. The electronics package 110 may additionally be comprised of a threshold determining hardware device 206 which is coupled to the FIFO data buffer 204. In some embodiments, the threshold determining hardware device 206 is incorporated into the FIFO data buffer 204; while in other embodiments, the hardware device 206 is incorporated into the display subsystem 214. Processing logic 200 sends data to display subsystem 214 through system interconnect 208 and fills FIFO data buffer 204. System interconnect 208 and storage 202 have a variable response latency which is system and scenario dependent.

FIFO data buffer 204 is a region of memory which stores data from processing logic 200 prior to the data being read by display subsystem 214. The data loaded into FIFO data buffer 204 by processing logic 200, thus, comprises graphics data, but also may include other than graphics data as well. Display subsystem 214 reads data from FIFO data buffer 204, and thus, the amount of unread data in FIFO data buffer 204 begins to fall. FIFO data buffer 204 is programmed with a data threshold level; hence, when the data level drops below the threshold level, processing logic 200 begins to write more data to FIFO data buffer 204. This process of processing logic 200 writing data to FIFO data buffer 204 and display subsystem 214 reading data from FIFO data buffer 204 continually repeats itself, so that FIFO data buffer 204 always has data in it.

FIFO data buffer 204 may write data to display subsystem 214 as bursts of data. That is to say, data may be written to display subsystem 214 in packets of data so as to supply display subsystem 214 with data as needed. FIFO data buffer 204 may also write data continually to display subsystem 214 as well.

In the preferred embodiment, threshold determining hardware device 206 is used to determine whether the threshold level of FIFO data buffer 204 has been crossed. However, in other embodiments, a byte counter, or any other suitable method, can determine if the threshold level has been crossed. The initial threshold level is set to an initial, pre-determined level so as to ensure that FIFO data buffer 204 will not underflow, which is to say, FIFO data buffer 204 will always have data in it. This initial level is set, for example, during initialization of electronics package 110. Hence, this original threshold level is set to a relatively high level so as to ensure that processing logic 200 will write data to FIFO data buffer 204 prior to FIFO data buffer 204 running empty of data. This is often referred to as setting the threshold level to the “worst case scenario.” The initial level depends on various factors, such as, the response latency time of system interconnect 208 and storage 202. The faster storage 202 can respond to display subsystem 214 the lower the initial threshold level may be set. Processing logic 200, along with peripheral logic which reads data from storage 202 in parallel will influence this latency.

As mentioned above, threshold determining hardware 206 is coupled to FIFO data buffer 204. Threshold determining hardware 206 preferably is capable of dynamically changing the threshold level (e.g., during run time) one or more times. For example, threshold determining hardware 206 is capable of adjusting downwards the initial threshold level of FIFO data buffer 204 and any subsequent threshold levels that are set. As such, FIFO data buffer 204 will be closer to being empty before processor logic 200 is triggered to refill the buffer. Thus, processing logic 200 will be required to write data to FIFO data buffer 204 less frequently. Because processing logic 200 writes data less frequently to FIFO data buffer 204, mobile communication device 100 saves power, as will be discussed further below.

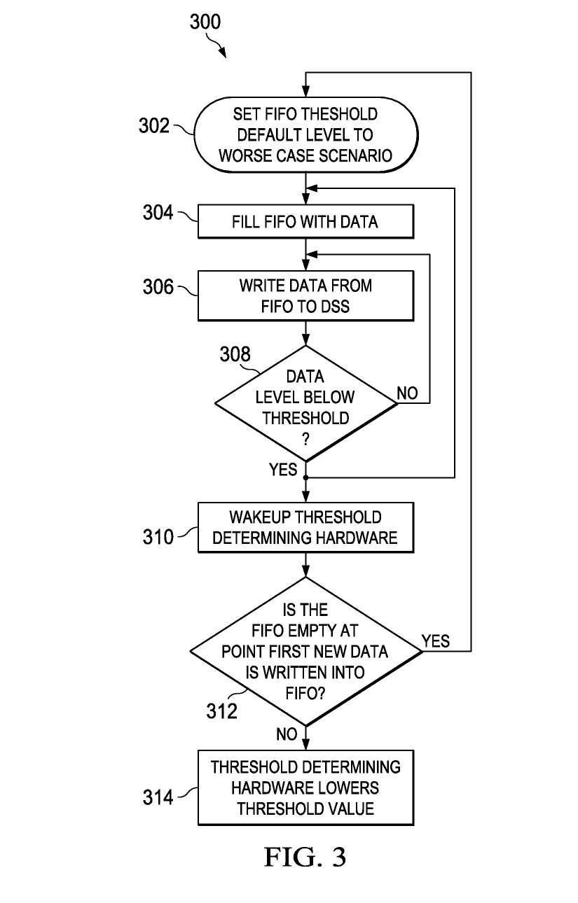

FIG. 3 shows an illustrative flow diagram of a method 300 implemented in accordance with various embodiments of the invention. The method 300 begins by setting the default, initial threshold level to the worst case scenario in block 302. As mentioned above, this is a relatively high value (e.g. 50% of FIFO data buffer's 204 size), so as to help ensure that FIFO data buffer 204 does not run out of data. In block 304, processing logic 200 writes data to FIFO data buffer 204 so that FIFO data buffer 204 is filled with data. FIFO data buffer 204 may be completely filled or may be filled to a level that is less than completely filled. For example, FIFO data buffer 204 may have a second threshold level, a high level threshold, which determines what level of data should be written into FIFO data buffer 204 during this filling of the buffer. In block 306, data that has been stored in FIFO data buffer 204 is written to display subsystem 214 in bursts of data or continually. If the data is written as a burst, the data is written to display subsystem 214 in packets of data so as to supply display subsystem 214 with data as needed. While data is being retrieved from FIFO data buffer 204 and provided to display subsystem 214, it is determined whether the data level in FIFO data buffer 204 ever falls below the threshold level (block 308). This may be accomplished by using threshold determining hardware 206 or using a standard byte counter, or any other suitable method. If the data in FIFO data buffer 204 has not fallen below the threshold level, more data is written from FIFO data buffer 204 into display subsystem 214 as shown in block 306. However, if the data level falls below the threshold level, two actions occur. First, FIFO data buffer 204 is filled with data, as seen in block 304. Also, threshold determining hardware 206 is woken up by processing logic 200 as shown in block 310 if threshold determining hardware 206 is not being used to monitor FIFO data buffer's 204 data level (i.e., a separate byte counter is being used). If this embodiment is chosen, power consumption is thus, further reduced because threshold determining hardware 206 is not always being used.

In block 312, threshold determining hardware 206 determines whether FIFO data buffer 204 has underflowed. That is to say, threshold determining hardware 204 must determine whether FIFO data buffer 204 has run empty (i.e., run dry). If threshold determining hardware 206 determines that FIFO data buffer 204 has underflowed, then threshold determining hardware 206 adjusts the threshold level back to the default, initial worst case scenario threshold level in block 302.

However, if FIFO data buffer 204 does not run empty, in block 314, threshold determining hardware 206 lowers the threshold level. In one embodiment, block 314 is accomplished by having threshold determining hardware 206 lower the threshold level to a level equal to the current threshold level minus the amount of data remaining in FIFO data buffer 204 at the moment the first data of a new data burst, being written from processing logic 200 to FIFO data buffer 204, is stored in FIFO data buffer 204. In alternative embodiments, the threshold determining hardware 206 uses other means of lowering the threshold level. By lowering the threshold level when suitable, processing logic 200 will be required to refill FIFO data buffer 204 less often, thus requiring less power because storage 202 and system interconnect 208 may be placed into a standby mode for a longer period of time while display subsystem 214 internally processes data from FIFO data buffer 204.

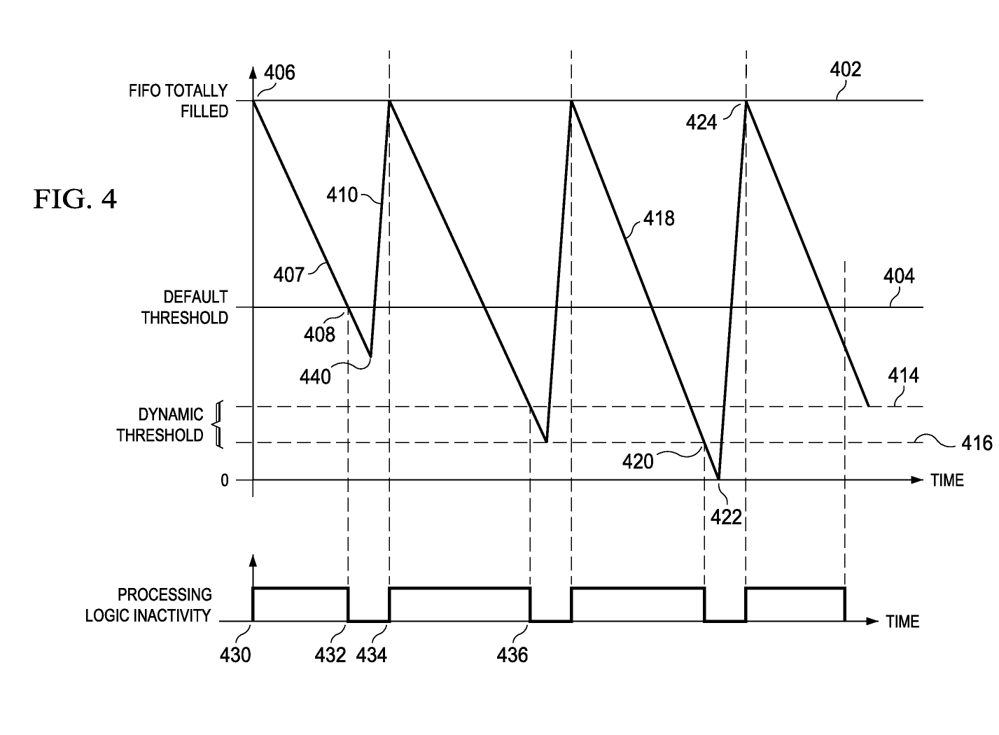

FIG. 4 shows a conceptual illustration of the technique in accordance with embodiments of the invention. Specifically, FIG. 4 shows an exemplary Level of Data in FIFO data buffer 204 versus Time graph. Line 402 on the graph illustrates the level of data that would completely fill FIFO data buffer 204. However, FIFO data buffer 204 does not need to be completely filled with data in alternative embodiments and line 406 may represent a second threshold level, a high level threshold. Line 404 illustrates the default, initial threshold level. At time 0, point 406, FIFO data buffer 204 is completely filled with data. At this point display subsystem 214 begins to read data either in bursts or continually from FIFO data buffer 204. Line 407 illustrates the data level in FIFO data buffer 204 decreasing. At point 408, the data level in FIFO data buffer 204 has reached the initial threshold level 404 and processing logic 200 is asked to refill FIFO data buffer 204 with more data. However, storage 202 and system interconnect 208 cannot provide display subsystem 214 with new data immediately, so the data level in FIFO data buffer 204 continues to decrease.

Once FIFO data buffer 204 begins receiving the new data from storage 202 and system interconnect 208, the data level in FIFO data buffer 204 has reached point 440. At this point, threshold determining hardware 206 adjusts the threshold down to level 414. This is accomplished by subtracting the remaining data in FIFO data buffer 204 at point 440 from the current threshold level 404 to produce a new threshold level 414. In the preferred embodiment, a configurable security margin is also subtracted from current threshold level 404 in calculating the new threshold level 414. This is used to avoid generating data underflow in FIFO data buffer 204; however, a security margin is not required. Because storage 202 and system interconnect 208 write data to FIFO data buffer 204 faster than display subsystem 214 is able to read data from FIFO data buffer 204, the level of data in FIFO data buffer 204 increases (represented by line 410). When the level of data in FIFO data buffer 204 reaches level 406, storage 202 and system interconnect 208 stop writing new data to FIFO data buffer 204.

This process then repeats itself with the new threshold level 414 used for the FIFO data buffer 204 which establishes another even lower threshold level 416. The process continues until an underflow would occur if the threshold level were lowered. For example, line 418 shows display subsystem 214 reading data from FIFO data buffer 204. When the data level in FIFO data buffer 204 reaches threshold level 416 at point 420 the processing logic 200, storage 202, and system interconnect 208 are not able to wakeup and write data to FIFO data buffer 204 in time to keep data in FIFO data buffer 204. This results in underflow in FIFO data buffer 204 at point 422. At this point, threshold determining hardware 206 adjusts the threshold level to the default, initial threshold, in this case 404. The whole method begins over again at point 424.

FIG. 4 also illustrates how processing logic 200, storage 202, and system interconnect 208 are less active using the described method. From points 430 to 432, which corresponds to the time between points 406 to 408 mentioned above, processing logic 200 is inactive, at least with regards to writing data to FIFO data buffer 204. This is because FIFO buffer 204 has sufficient data to be above threshold level 404. However, once data burst 407 drains enough data from FIFO data buffer 204 to reach threshold level 404, processing logic 200 must become active and write data to FIFO data buffer 204. Thus, the time between point 432 and point 434 is chip activity. Once the threshold level is lowered to threshold level 414 the time processing logic 200 is inactive becomes longer as shown in the fact that the time between points 434 and 436 is longer than between 430 and 432. Thus over time, processing logic 200, along with storage 202 and system interconnect 208, is woken up less often than if threshold level 404 remained constant. This in turn reduces power consumption for the system.

It is noted here that a threshold determining hardware such as that disclosed herein creates several potential advantages. Because the processing logic is required to write data to the FIFO data buffer less frequently, the idle time of the processing logic's interconnect with the FIFO data buffer is maximized. With a maximized idle time for the processing logic's interconnect, the low power refresh mode is dramatically more efficient because the power consumption is drastically reduced. Also, the use of hardware to adjust the threshold value of the FIFO data buffer allows for real-time monitoring and tuning of the actual threshold value which software would not allow. A software solution, thus, would be required to always use a “worst case scenario” threshold level.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system comprising:
a first-in, first-out (“FIFO”) buffer containing a programmable threshold level; and
a hardware device coupled to said FIFO buffer and configured to dynamically adjust the FIFO buffer's threshold level.

2. The system of claim 1, further comprising:
a processor configured to send data to the FIFO buffer; and
a display subsystem configured to receive data from the FIFO buffer.

3. The system of claim 1, wherein the hardware device is configured to determine whether a data level inside the FIFO buffer has crossed the threshold level.

4. The system of claim 3, wherein the hardware device is configured to adjust the threshold level by subtracting the amount of remaining data in the FIFO buffer at the time new data enters the FIFO buffer from the threshold level to produce a new threshold level.

5. The system of claim 1, wherein the threshold level is initialized to a pre-determined level; and
wherein said pre-determined level is set to a level so that the FIFO buffer does not underflow.

6. The system of claim 5, wherein the hardware device is configured to adjust the threshold level to the pre-determined level if the FIFO buffer underflows.

7. The system of claim 1, further comprising a processor that is configured to write data to the FIFO buffer once the data level inside the FIFO buffer has crossed the threshold level.

8. The system of claim 1, wherein the FIFO buffer contains the hardware device.

9. The system of claim 1, further comprising a display subsystem that contains the hardware device.

10. The system of claim 1, wherein the system comprises a mobile communications device.

11. A method comprising:
reading data from a FIFO buffer;
while reading said data, detecting whether a FIFO buffer threshold level has been crossed; and
lowering the threshold level if there would be data left in the FIFO buffer when new data is stored in the FIFO buffer.

12. The method of claim 11, wherein lowering the threshold level comprises subtracting the amount of remaining data in the FIFO buffer at the time new data enters the FIFO buffer from the threshold level to produce a new threshold level.

13. The method of claim 11, further comprising storing new data in the FIFO buffer when the threshold level is crossed.

14. The method of claim 11 further comprising adjusting the threshold level to a pre-determined threshold level if the FIFO buffer underflows.

15. A system, comprising:
means for reading data from a FIFO buffer;
means for detecting whether a FIFO buffer threshold level has been crossed; and
means for lowering the threshold level.

16. The system of claim 15, wherein the means for lowering the FIFO threshold level is subtracting the amount of remaining data in the FIFO buffer at the time new data enters the FIFO buffer from the threshold level to produce a new threshold level.

17. The system of claim 15, wherein the means for reading data is for reading graphics data from the FIFO buffer to a display.

18. The system of claim 15, further comprising means for adjusting the threshold level to an initial pre-determined threshold level if the FIFO buffer underflows.

19. The system of claim 15, further comprising means for storing new data in the FIFO buffer when the threshold level is crossed.

20. The system of claim 15, wherein the system is a mobile communications device.
